(19) United States
(12) Patent Application Publication
(10) Pub. No.: US 2023/0020080 A1
(43) Pub. Date: Jan. 19, 2023

(54) RELATIONSHIP BUILDER TO RELATE DATA ACROSS MULTIPLE ENTITIES/NODES

(71) Applicants: ADISHESH KISHORE, Bengaluru (IN); VISHNU VASANTH BINDIGANAVALE, BENGALURU (IN); AAQUIB JAVED KHAN, bengaluru (IN)

(72) Inventors: ADISHESH KISHORE, Bengaluru (IN); VISHNU VASANTH BINDIGANAVALE, BENGALURU (IN); AAQUIB JAVED KHAN, bengaluru (IN)

(21) Appl. No.: 17/718,315

(22) Filed: Apr. 12, 2022

Related U.S. Application Data
(60) Provisional application No. 63/173,499, filed on Apr. 12, 2021.

(51) Int. Cl. G06F 16/21; G06F 16/22

(52) U.S. Cl. CPC G06F 16/211; G06F 16/2272; G06F 16/2246

(57) ABSTRACT

A method for implementing a relationship builder to relate data across multiple entities of a database system, comprising the steps of: providing a set of data sets across multiple entities in the database system, wherein an entity comprises a set of structured data or a set of semi-structured data; identifying a set of relationships across the set of datasets without any prior schema knowledge of the set of data sets; testing and discarding relationships et of relationships across the set of datasets that are detected as a negative; referring a set of remaining relationships which have not been discarded as a set of tested possible relationships; validating the set of tested possible relationships by applying an initial filtering algorithms to remove any false positives comprising a distilled relation; and determining a set of tested possible relationships as comprising a set of true relationships applying a set of graph algorithms.

### CLAIM OF PRIORITY

This application claim priority to U.S. Provisional Patent Application No. 63173499, filed on 12 Apr. 2021, and titled AUTONOMOUS RELATIONSHIP DETECTION ACROSS DISPARATE STRUCTURED & SEMI STRUCTURED DATA SETS. This provisional application is hereby incorporated by reference in its entirety.

### BACKGROUND

Current database management solutions need more automated data integration and auto modeling features. Current solutions do not have the ability to ingest and uncover hidden relationships in disparate datasets. In this context, current solutions do not adequately provide user the ability to write SQL queries across multiple datasets (e.g. coming from different data sources) without specifying joins. During the testing/pre-launch phase do not include sufficient insights of how large-scale analytical queries should be executed (e.g. as opposed to how they are executed today on both MapReduce and/or MPP style engines). Accordingly, improvements that include an SQL engine that is orders of magnitude more performant than any existing approaches are needed.

### SUMMARY OF THE INVENTION

A method for implementing a relationship builder to relate data across multiple entities of a database system, comprising the steps of: providing a set of data sets across multiple entities in the database system, wherein an entity comprises a set of structured data or a set of semi-structured data; identifying a set of relationships across the set of datasets without any prior schema knowledge of the set of data sets; testing and discarding relationships et of relationships across the set of datasets that are detected as a negative; referring a set of remaining relationships which have not been discarded as a set of tested possible relationships; validating the set of tested possible relationships by applying an initial filtering algorithms to remove any false positives comprising a distilled relation; and determining a set of tested possible relationships as comprising a set of true relationships applying a set of graph algorithms.

### BRIEF DESCRIPTION OF THE DRAWINGS

FIG. 1 illustrates an example process for relationship builder to relate data across multiple entities/nodes, according to some embodiments.

FIG. 2 illustrates an example process of a relationship building phase, according to some embodiments.

FIG. 3 illustrates an example process for implementing a subset detection phase, according to some embodiments.

FIG. 4 illustrates an example process for implementing step, according to some embodiments.

FIG. 5 illustrates an example graph-validation phase process, according to some embodiments.

FIG. 6 depicts the sample graph traversal across the columns present, according to some embodiments.

The Figures described above are a representative set and are not exhaustive with respect to embodying the invention.

### DESCRIPTION

Disclosed are a system, method, and article of manufacture for relationship builder to relate data across multiple entities/nodes. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

DEFINITIONS

Example definitions for some embodiments are now provided.

Apache Parquet® (i.e. Parquet) is a free and open-source column-oriented data storage format of the Apache Hadoop ecosystem. Parquet provides efficient data compression and encoding schemes with enhanced performance to handle complex data in bulk.

Application programming interface (API) can be a computing interface that defines interactions between multiple software intermediaries. An API can define the types of calls and/or requests that can be made, how to make them, the data formats that should be used, the conventions to follow, etc. An API can also provide extension mechanisms so that users can extend existing functionality in various ways and to varying degrees.

Data schema can refer to the organization of data as a blueprint of how the data (e.g. in a database) is constructed and divided.

SQL (Structured Query Language) is a domain-specific language used in programming and designed for managing data held in a relational database management system (RDBMS), or for stream processing in a relational data stream management system (RDSMS).

EXAMPLE METHODS AND SYSTEMS

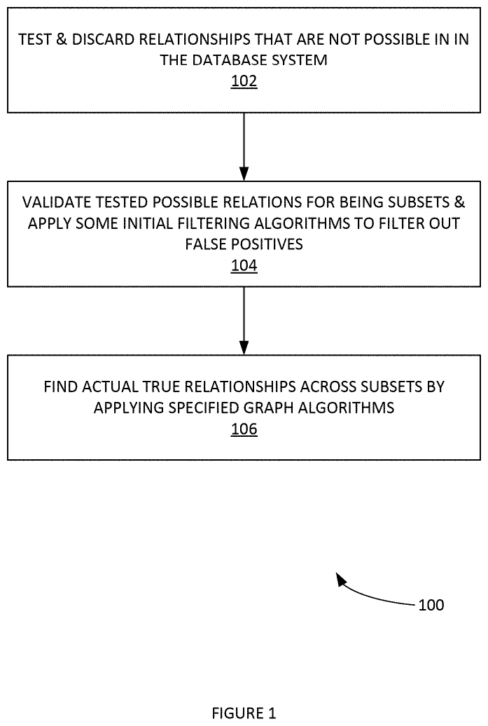

FIG. 1 illustrates an example process 100 for relationship builder to relate data across multiple entities/nodes, according to some embodiments. It is noted that a goal of the relationship builder can be to relate data across multiple entities/nodes in the database system (e.g. that includes/coupled with an E6X engine, etc.). Such entities can be part of the same or different datasets and could contain structured or semi-structured data. Process 100 identifies the relationships across those datasets without any prior schema knowledge. The relationship building phase consists of three stages.

More specifically, in step 102 process 100 can test and discard relationships that are detected as negative from the underlying data. Any remaining relationships which have not been discarded can be referred to as possible relations.

In step 104, process 100 can validate the tested possible relations for being subsets and apply some initial filtering algorithms to weed out false positives. As used herein, these can be referred to as distilled relations.

In step 106, process 100 can find the actual true relationships across subsets by applying our graph algorithms.

The data can be from the various data sources that are intended to be used while building the relationships. Data sources can be any of the relational databases such as Postgres, MySQL, Oracle and/or NoSQL databases (e.g. Mongo®, Cassandra®, Hive®) and/or individual file systems (such as CSV, EXCEL®, JSON formats, etc.). Once the ingestion is complete, the data is dumped into a Parquet format (and/or other similar type of format, etc.) in our filesystem that we use. An Apache Parquet° reader (and/or other database reader) can be customized to handle any given data schema and write the data to our filesystem.

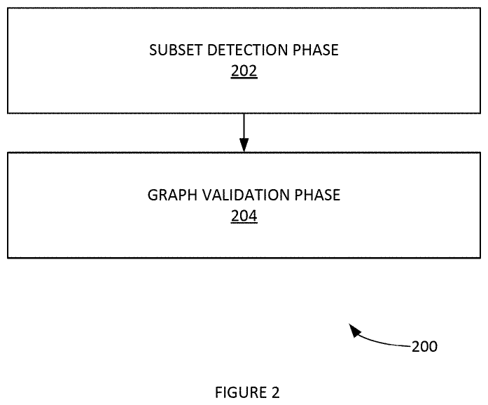

FIG. 2 illustrates an example process 200 of a relationship building phase, according to some embodiments. The relationship building phase is a two-step process that can be executed by a relationship builder. In step 202, process 200 can implement a subset detection phase. The subset detection phase is responsible for testing joins between various fields of the datasets being operated on.

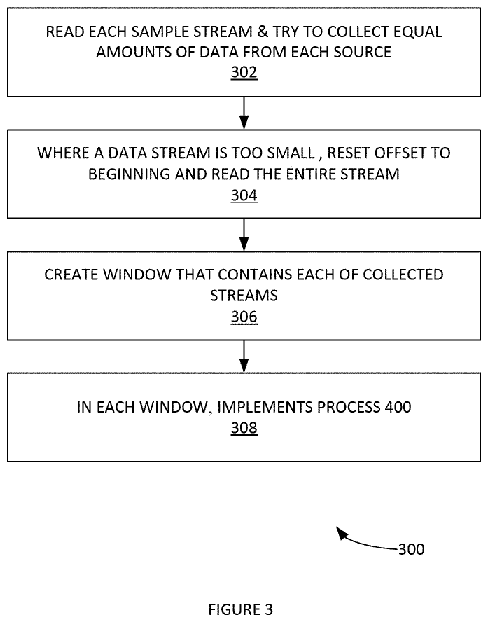

FIG. 3 illustrates an example process 300 for implementing a subset detection phase, according to some embodiments. In step 302, process 300 can read each sample stream and try to collect equal amounts of data from each source. In step 304, where a data stream cannot offer equal amounts of data as the other streams, we read the stream from the first data point in the stream. In step 306, process 300 can create a window that can contain each of the collected streams. In step 308, in each window, process 300 implements process 400.

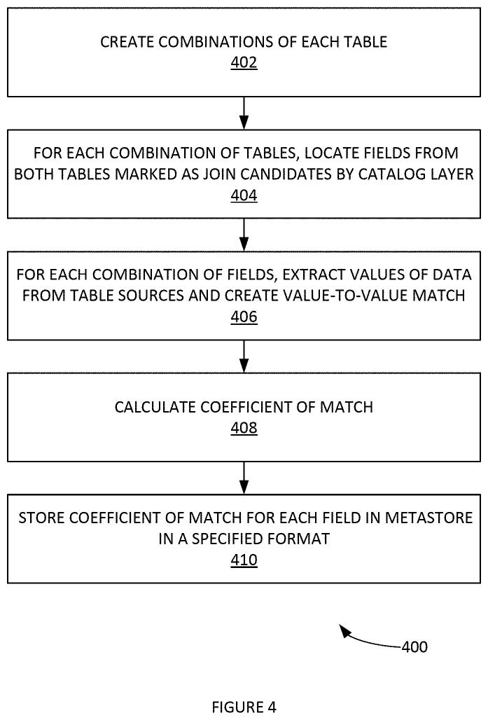

FIG. 4 illustrates an example process for implementing step 308, according to some embodiments. In step 402, process 400 can create combinations of each table. For example, if there are three (3) tables in your sources a, b, c the combinations created can be as follows:

a,b

b,c

a,c

In step 404, for each combination of tables, process 400 locates fields from both tables marked as join candidates by the catalog layer. This layer detects the schema present in any streaming data and determines the datatype of each of the columns. The catalog layer automatically infers the schema. For example, process 400 can determine one field in table 1, e.g. F1T1 and two fields in table 2, e.g. F1T2, F2T2 which are matched in the distilling stage, then the combinations step 404 can create are:

F1T1, F1T2,

F1T1, F2T2,

In step 406, for each combination of fields, process 400 extracts the values of the data from the table sources and create a value-to-value match. Here, an ideal case can be a match which is close to the sampling % that is selected in the catalog layer.

In step 408, process 400 can calculate the coefficient of match. This can be: Total number of successful matches/Minimum(Length of FnTn, Length FmTm).

In step 410, process 400 can store coefficient of match for each field in the metastore in a specified format:

Source table, field name, destination table, field name and coefficient; and

The coefficient represents a possible join in the datasets.

Once each of these join coefficients is calculated the data is discarded in this phase. The relationship-building phase can be completely stateless and does not care about any of the previous windows that were created. The data in the metastore can be upserted in the relationship-building phase. This can ensure that the final data of the join coefficients in the metastore is cumulative. Every window can only strengthen joins but not penalize the joins if no evidence of joins is found. This can ensure that process 400 makes every possible join and do not miss out on any fields that may join.

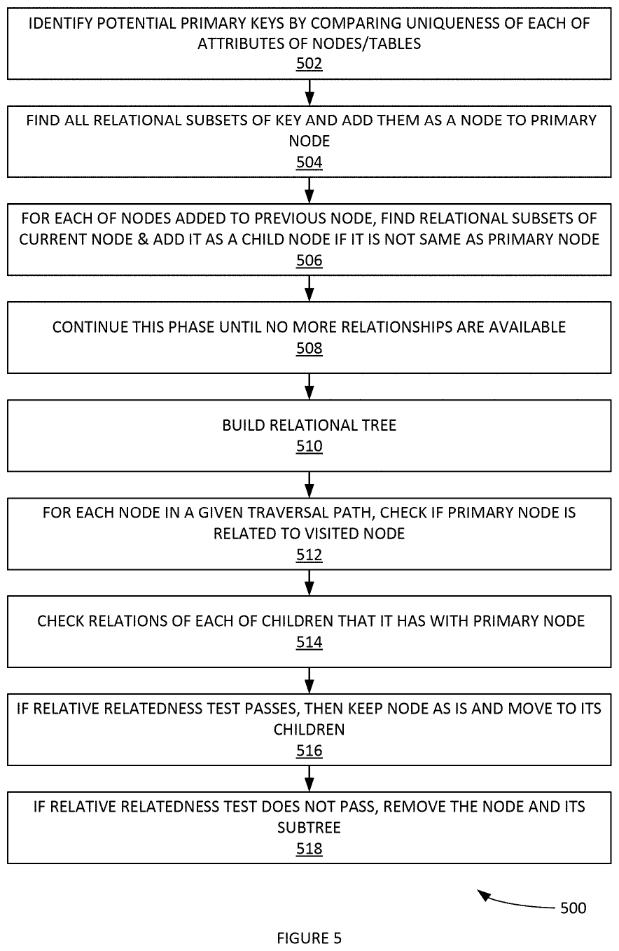

Returning to process 200, in step 202, process 200 implements a graph validation phase. FIG. 5 illustrates an example graph-validation phase process 500, according to some embodiments. The graph validation phase is responsible for the pruning of joins that are identified as subsets by the subset detection phase discussed supra. Once the subsets are detected the following steps are carried out in order to prune out false positives from the set of identified subsets.

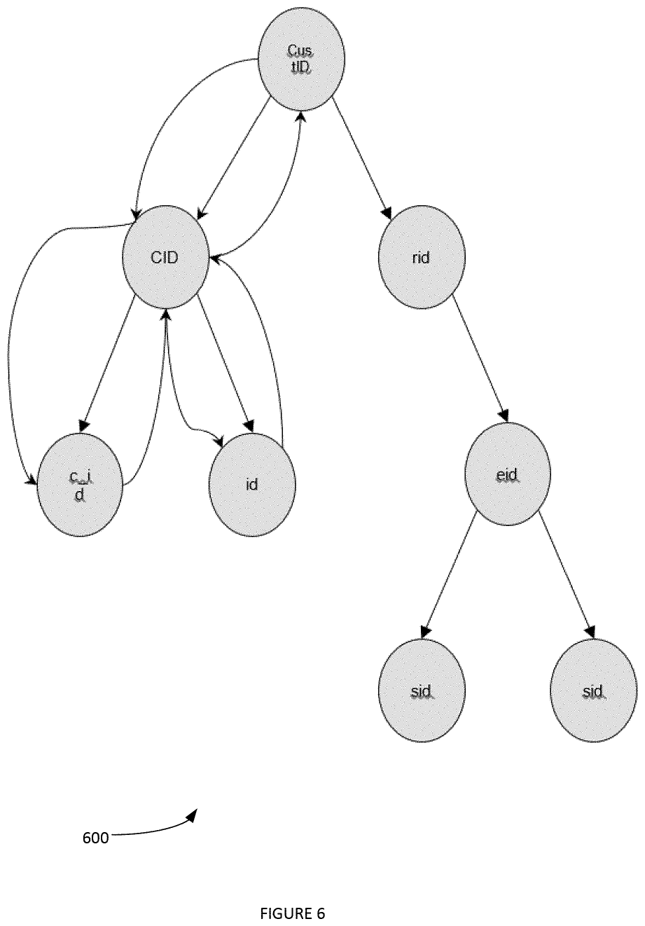

In step 502, process 500 can identify potential primary keys by comparing the uniqueness (e.g. cardinality) of each of the attributes (e.g. columns) of the nodes/tables. If the cardinality is approximately equal to the number of records in a given node, mark it as a potential primary key. This can be performed for each of the identified unique keys (e.g. refer to FIG. 6 infra).

In step 504, process 500 can find all relational subsets of the key and add them as a node to the primary node. In step 506, process 500 can, for each of the nodes added to the previous node, find relational subsets of the current node, and add it as a child node if it is not the same as the primary node.

It has not been added to the current traversal path as an ancestor. This will ensure no cyclic relations are present in the tree. Process 500 can continue this phase until no more relationships are available in step 508.

In step 510 process 500 can build the relational tree. Once the relational tree is built the following steps are carried out on the tree,(refer diagram for the traversal paths). We basically use a depth-first search algorithm to traverse the children of the tree.

In step 512, for each node in a given traversal path, process 500 can check if the primary node is related to the visited node. If yes, then process 500 can check the relations of each of the children that it has with the primary node in step 514.

If the relative relatedness test passes, then keep the node as is and move to its children in step 516. Process 500 can repeat the applicable steps until the last child in the tree. If no, process 500 can remove the node and its subtree in step 518.

FIG. 6 depicts an example graph traversal across the columns present, according to some embodiments. The curved lines represent the traversal methodology that are followed. It is basically the widely used depth first search method. Once all subtrees are invalidated, the graph traversal process can remove rid which only leaves the left-hand side portion of the graph as a truly validated set of relations. It is noted that EID is not a relation of custlD so the graph traversal process can remove this and its subtree.

CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing a relationship builder to relate data across multiple entities of a database system, comprising the steps of:
providing a set of data sets across multiple entities in the database system, wherein an entity comprises a set of structured data or a set of semi-structured data;
identifying a set of relationships across the set of datasets without any prior schema knowledge of the set of data sets;
testing and discarding relationships et of relationships across the set of datasets that are detected as a negative;
referring a set of remaining relationships which have not been discarded as a set of tested possible relationships;
validating the set of tested possible relationships by applying an initial filtering algorithms to remove any false positives comprising a distilled relation; and
determining a set of tested possible relationships as comprising a set of true relationships applying a set of graph algorithms.

2. The method of claim 1, wherein each entity comprises a database node.

3. The method of claim 1, wherein the step of determining the set of tested possible relationships further comprises:
implementing a relationship building phase comprising a two-step process.

4. The method of claim 3, wherein the two-step process of the relationship building phase comprises:
implementing a subset detection phase, wherein the subset detection phase tests joins between a set of fields of the set of data with the set of tested possible relationships.

5. The method of claim 4, wherein the two-step process of the relationship building phase comprises:
implementing a graph validation phase, wherein the graph validation phase.

6. The method of claim 5, wherein the graph validation phase comprises a pruning of the set of joins that are identified as subsets by the subset detection phase.

7. The method of claim 6, wherein once the subsets are detected all the false positives are pruned from the set of identified subsets.

8. The method of claim 7, wherein the step of implementing the subset detection phase further comprises:
reading each sample data stream and collecting equal amounts of data from each source.

9. The method of claim 8, wherein the step of implementing the subset detection phase further comprises:
creating a window that can contain each of collected data stream.

10. The method of claim 9, wherein the step of implementing the subset detection phase further comprises:
creating a set of combinations of each data table.

11. The method of claim 10, wherein the step of implementing the subset detection phase further comprises:
for each combination of data tables, locating a set of fields from each of the data tables marked as join candidates by a catalog layer.

12. The method of claim 11, wherein the catalog layer detects the schema present in any streaming data and determines a datatype of each of a set columns, and wherein the catalog layer automatically infers the schema.

13. The method of claim 12, wherein for each combination of data fields:
extracting the values of the streaming data from the table sources;
creating a value-to-value match for the data of the streaming data;
calculating a coefficient of match for the value-to-value match; and
storing the coefficient of the value-to-value match for each field in a metastore in a specified format.

14. The method of claim 5, wherein the step of implementing the graph detection phase further comprises:
locating all relational data subsets of a key and add the relational data subsets as a node to a primary node;
for each of the nodes added to the primary node, finding a set of relational subsets of a current node; and
adding the set of relational subsets of a current node as a child node when it is not the same as the primary node.

15. The method of claim 14, wherein the step of implementing the graph detection phase further comprises:
building a relational tree.

16. The method of claim 15, wherein the step of implementing the graph detection phase further comprises:
once the relational tree is built:
using a depth-first search algorithm to traverse the children of the relational tree;
for each node in a given traversal path:
checking that the primary node is related to a visited node;
checking the relations of each of the children that it has with the primary node;
when the relative relatedness test passes:
keeping the node as is and move to its children nodes;
repeating the applicable steps until the last child in the relational tree.
